(19) United States
(12) Patent Application Publication
(10) Pub. No.: US 2026/0192960 A1
(43) Pub. Date: Jul. 9, 2026

(54) HEAT-SEALING STRUCTURE FOR TRASH CAN

(71) Applicant: EKO GROUP LTD, Jiangmen (CN)

(72) Inventor: Yizhi CHEN, Jiangmen (CN)

(21) Appl. No.: 19/553,556

(22) Filed: Mar. 2, 2026

(30) Foreign Application Priority Data
Sep. 8, 2025 (CN) 202521934218.4

(51) Int. Cl. B65B 51/14; B65F 1/06; B65F 1/14

(52) U.S. Cl. CPC B65B 51/146; B65F 1/06; B65F 1/14

(57) ABSTRACT

A heat-sealing structure for a trash can includes an abutting assembly and a heating element. The abutting assembly is provided on a first gathering component. The abutting assembly is spaced apart from a first contact area, and protrudes beyond the first contact area. The abutting assembly is configured to press against a garbage bag to eliminate a gap after the garbage bag is gathered, thereby ensuring two sides of the garbage bag in contact with each other. The heating element is provided on a second gathering component. The heating element is spaced apart from a second contact area, and protrudes beyond the second contact area. The heating element is spaced apart from the abutting assembly, and is configured to thermally seal the garbage bag.

### CROSS-REFERENCE TO RELATED APPLICATIONS

This application claims the benefit of priority from Chinese Patent Application No. 202521934218.4, filed on September 8, 2025. The content of the aforementioned application, including any intervening amendments thereto, is incorporated herein by reference in its entirety.

### TECHNICAL FIELD

This application relates to trash cans, and more particularly to a heat-sealing structure for a trash can.

### BACKGROUND

For the existing trash cans, it is generally required to gather the bag opening to a preset fixing area at the top of the trash can via a mechanical mechanism, and then thermally seal the bag opening through a heat-sealing mechanism installed at the fixing area to complete the packaging and sealing of the garbage bag. However, excessive wrinkles may occur at the gathered bag opening, making the gathered section too thick and uneven. Recently, horizontal-push type trash cans have emerged, in which a drive mechanism drives a gathering assembly to approach and gather the garbage bag, and a heating element simultaneously performs thermal sealing and cutting on the garbage bag. However, there is still a gap left between two sides of the bag opening during the gathering process, failing to reach the complete heat-sealing effect. As a consequence, odor leakage or seal breakage may easily occur.

### SUMMARY

In view of the deficiencies in the prior art, this application provides a heat-sealing structure for a trash can, the trash can comprising a gathering assembly, the heat-sealing structure being arranged in the gathering assembly, the gathering assembly comprising a first gathering component and a second gathering component, the first gathering component having a first contact area, the second gathering component having a second contact area, the first contact area being configured to be in contact with the second contact area, a garbage bag being configured to be gathered between the first contact area and the second contact area, and the heat-sealing structure comprising:

an abutting assembly; and

a heating element;

wherein the abutting assembly is arranged at the first gathering component; the abutting assembly is arranged spaced apart from the first contact area and protruding beyond a plane where the first contact area is located; the abutting assembly is configured to press against the garbage bag to eliminate a gap after the garbage bag is gathered, thereby ensuring two sides of the garbage bag in contact with each other; and

the heating element is arranged at the second gathering component; the heating element is arranged spaced apart from the second contact area and protruding beyond the second contact area; and the heating element is arranged spaced apart from the abutting assembly, and is configured to thermally seal the garbage bag.

In an embodiment, the abutting assembly comprises a positioning part and a protruding part; the positioning part is arranged at the first gathering component; the protruding part is arranged on a side of the positioning part; and the protruding part is arranged spaced apart from the first contact area and protruding beyond the first contact area.

In an embodiment, the protruding part comprises a first edge and a second edge; a first end of the first edge is connected to the positioning part, and a second end of the first edge protrudes beyond the first contact area and is connected to the second edge; and the second edge is configured to extend obliquely from the second end of the first edge and pass through at least a portion of the second contact area and at least a portion of the first contact area.

In an embodiment, the protruding part further comprises a third edge; and a first end of the third edge is connected to the positioning part, and a second end of the third edge is connected to the second edge.

In an embodiment, the heat-sealing structure further comprises a mounting part; wherein the mounting part is provided on the second gathering component; the heating element is provided on a side of the mounting part facing toward the first gathering component; and the heating element is arranged perpendicular to an extension direction of the garbage bag.

In an embodiment, the heating element comprises a first bending part and a first heating part; an end of the first bending part is inserted into the mounting part; and a gap is provided between the abutting assembly and the first bending part for the garbage bag to pass through; and the first heating part is configured to thermally seal the garbage bag.

In an embodiment, the heating element further comprises a second bending part and a second heating part; a first end of the second bending part is connected to an end of the first heating part; a second end of the second bending part is connected to a first end of the second heating part; and a second end of the second heating part is inserted into the mounting part.

In an embodiment, an extension direction of the first heating part is parallel to an extension direction of the second heating part.

Compared to the prior art, this application has the following beneficial effects.

This application includes an abutting assembly and a heating element. The abutting assembly is arranged at the first gathering component and protrudes beyond the first contact area. The heating element is arranged at the second gathering component and protrudes beyond the second contact area. There is a gap left between two sides of the bag opening during the gathering process, resulting in the poor heat-sealing effect. By utilizing the abutting assembly to press against the garbage bag, the gap between the two sides of the garbage bag can be eliminated, ensuring that the garbage bag remains tightly contact during gathering, resulting in uniform sealing and preventing air leakage.

### BRIEF DESCRIPTION OF THE DRAWINGS

In order to illustrate the embodiments of the present disclosure or the technical solution in the prior art more clearly, the drawings required in the description of the embodiments or the prior art will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 is a schematic diagram of a trash can according to one embodiment of the present disclosure;

FIG. 2 is a schematic diagram of an accommodating cavity of the trash can according to one embodiment of the present disclosure;

FIG. 3 is a schematic diagram of an internal structure of an accommodating groove of the trash can according to one embodiment of the present disclosure;

FIG. 4 schematically shows the structure of FIG. 3 in the absence of a support structure;

FIG. 5 is a perspective view of a drive mechanism of the trash can according to one embodiment of the present disclosure;

FIG. 6 is a top view of FIG. 4;

FIG. 7 is an enlarged view of portion A in FIG. 6;

FIG. 8 shows a positional relationship of an abutting assembly and a heating element according to one embodiment of the present disclosure;

FIG. 9 is a schematic diagram of the abutting assembly;

FIG. 10 is a schematic diagram of the heating element, a mounting part, and a first guiding inclined platform according to one embodiment of the present disclosure;

FIG. 11 schematically shows the heating element and the mounting part;

FIG. 12 is a schematic diagram of a rear pulley and a second guiding inclined platform;

FIG. 13 is a schematic diagram of the second guiding inclined platform;

FIG. 14 is a schematic diagram of a transmission unit;

FIG. 15 is a schematic diagram of a lead screw; and

FIG. 16 is a schematic diagram of a worm gear and the transmission unit in cooperation.

1-can body; 11-accommodating groove; 12-accommodating cavity; 121-opening; 13-guide rail; 14-sensor; 15-reset spring; 16-controller; 17-first direction; 18-second direction; 2-drive mechanism; 21-drive assembly; 211-motor; 212-transmission unit; 2121-transmission shaft; 2122-transmission gear set; 2123-first transmission gear; 2124-second transmission gear; 2125-first connecting section; 2126-second connecting section; 2127-connecting hole; 213-lead screw; 2131- insertion slot; 214-lead screw nut; 215-guide wheel; 22-transmission assembly; 221-worm gear; 222-transmission worm; 223-first bearing; 224-second bearing; 3- support structure; 31-first support bracket; 32-second support bracket; 33-third support bracket; 34-fourth support bracket; 4-first gathering component; 41-first contact area; 42-first drive pulley assembly; 43-first transmission belt; 44-first drive pulley; 45-second drive pulley; 46-third drive pulley; 47-tension pulley; 5-second gathering component; 51-second contact area; 52-second drive pulley assembly; 53-second transmission belt; 54-first transmission pulley; 55-second transmission pulley; 56-third transmission pulley; 6-heating element; 61-mounting part; 62-abutting assembly; 621-positioning part; 622-protruding part; 623-first edge; 624-second edge; 625-third edge; 63-first bending part; 64-first heating part; 65-second bending part; 66-second heating part; 7-synchronous pulley assembly; 71-first synchronous pulley; 72-second synchronous pulley; 73-synchronous belt; 74-idler gear; 8-rear pulley assembly; 81-rear pulley; 82-rear support block; 9-first guiding inclined platform; 91-first inclined surface; 92-second guiding inclined platform; 93-second inclined surface; 94-pushing arm; 941-pushing portion; 942-fixing portion; 943-clamping portion; 944-fixing hole; 95-connecting member; 96-retaining edge.

The technical solutions, objects and advantages of the disclosure will be further illustrated with reference to the drawings and in conjunction with the embodiments.

### DETAILED DESCRIPTION OF EMBODIMENTS

The technical solutions of the disclosure will be described in detail below in combination with the drawings in the embodiments. Obviously, described below are merely some embodiments of the disclosure, which are not intended to limit the disclosure. For those skilled in the art, other embodiments obtained based on these embodiments without paying creative efforts should fall within the scope of the disclosure defined by the appended claims.

As used herein, it should be noted that all orientation terms (such as “up”, “down”, “left”, “right”, “front”, “rear”) are only used to explain the relative positional relationships and movements among various components in a specific posture as shown in the accompanying drawings. If the specific posture changes, these orientation terms will change accordingly.

In addition, the terms “first” and “second” are merely descriptive, and cannot be understood as indicating or implying relative importance or the number of technical features specified. Thus, features defined as “first,” “second,” etc., may explicitly or implicitly include at least one such feature. Moreover, the term “and/or” throughout this disclosure encompasses three scenarios. Taking “A and/or B” as an example, it includes the technical solution A, the technical solution B, and the technical solution where both A and B are simultaneously satisfied. Furthermore, technical solutions from different embodiments may be combined, provided such combinations are achievable by a person skilled in the art. Where the combination of technical solutions results in mutual contradictions or impossibility of implementation, such a combination shall be deemed non-existent and falls outside the scope of the disclosure defined by the appended claims.

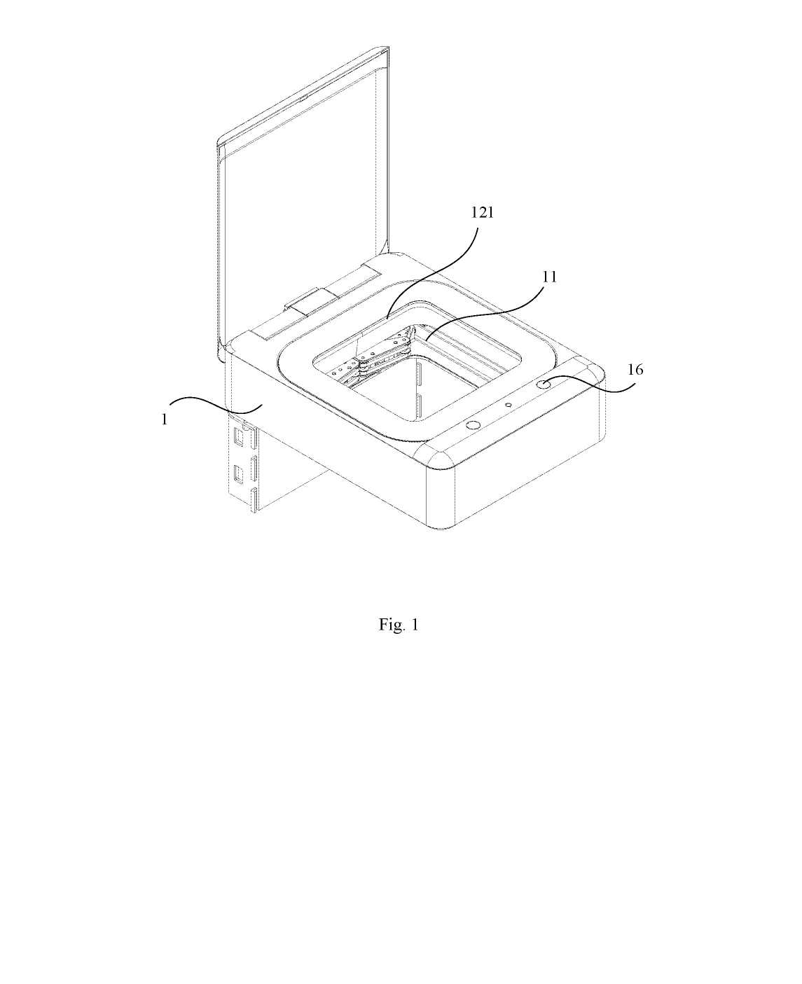

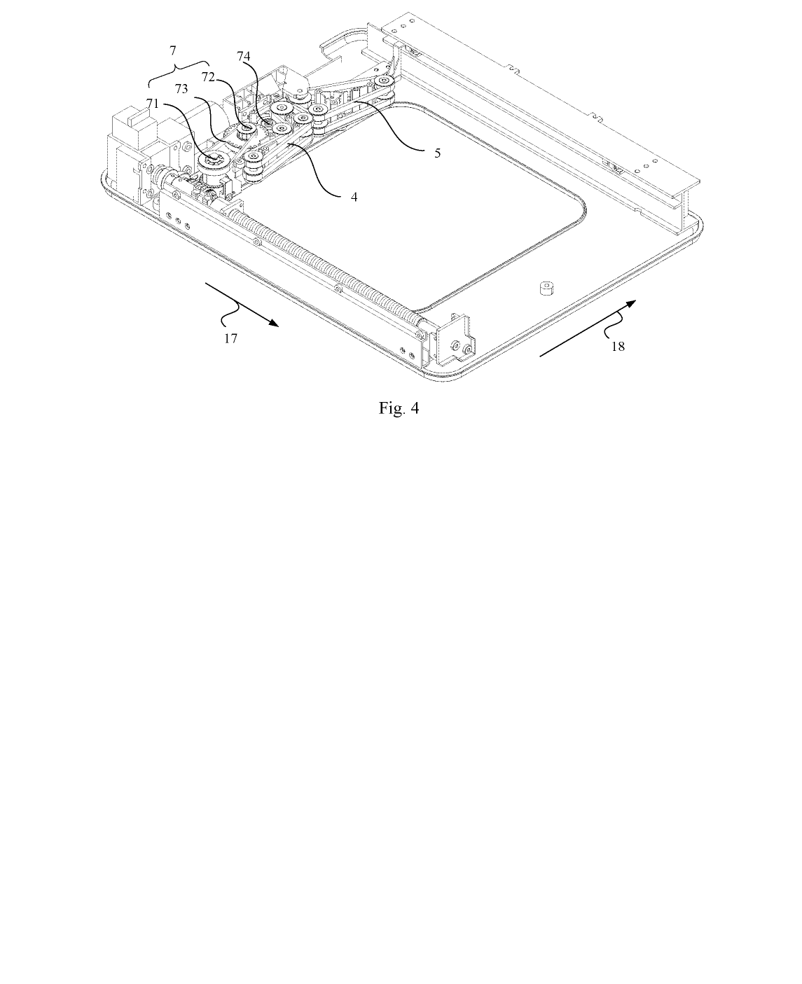

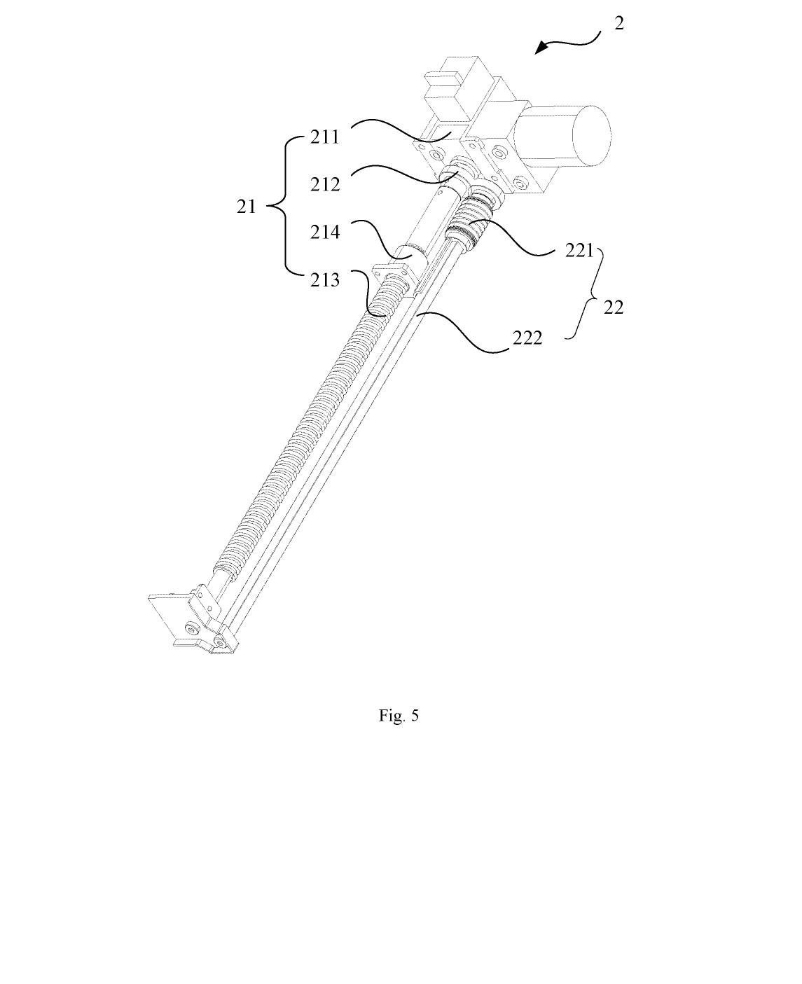

Referring to FIGS. 1-8, a trash can provided herein includes a can body 1, a drive mechanism 2, a support structure 3, a gathering assembly, and a heat-sealing structure. The gathering assembly includes a first gathering component 4 and a second gathering component 5. The heat-sealing structure includes a heating element 6. The interior of the can body 1 is provided with an accommodating groove 11 and an accommodating cavity 12 spaced apart along the height direction of the can body 1. The accommodating groove 11 is located below the accommodating cavity 12. The accommodating cavity 12 is used to hold the garbage bag, and an opening 121 is provided in the inner edge of the accommodating cavity 12 to allow the garbage bag to extend out. The drive mechanism 2 is arranged within the accommodating groove 11 along a first direction 17. The support structure 3 is arranged within the accommodating groove 11 along a second direction 18 perpendicular to the first direction 17. The support structure 3 is connected to the drive mechanism 2, which drives the support structure 3 to reciprocate along the first direction 17. The first gathering component 4 and the second gathering component 5 are both disposed within the support structure 3. Driven by the drive mechanism 2, the support structure 3 drives the first gathering component 4 and the second gathering component 5 to move along the first direction 17. The first gathering component 4 is in transmission connection with the drive mechanism 2, and the second gathering component 5 is in transmission connection with the first gathering component 4, thereby achieving synchronous rotation of the first gathering component 4 and the second gathering component 5. At least partial areas between the first gathering component 4 and the second gathering component 5 are in contact with each other, so as to gather the garbage bag into the contact area between the first gathering component 4 and the second gathering component 5. The heating element 6 is disposed within either the first gathering component 4 or the second gathering component 5, and the heating element 6 is configured to thermally seal the garbage bag.

This disclosure incorporates the drive mechanism 2 and the support structure 3, and the first gathering component 4 and the second gathering component 5 are disposed within the support structure 3. The drive mechanism 2 drives the first gathering component 4 and the second gathering component 5 to move along the first direction 17. The drive mechanism 2 is also in transmission connection with the first gathering component 4, and the first gathering component 4 is in transmission connection with the second gathering component 5. This arrangement enables the first gathering component 4 and the second gathering component 5 to rotate about their respective outer peripheral walls. The support structure 3 moves along the first direction 17 to drive the first gathering component 4 and the second gathering component 5 to continuously approach the garbage bag, thereby progressively gathering the garbage bag into the contact area between the first gathering component 4 and the second gathering component 5. Subsequently, the heating element 6 continuously thermally seals the garbage bag. Consequently, during the gathering process of the garbage bag, the first gathering component 4 and the second gathering component 5 approach the garbage bag, and gather both sides of the garbage bag into the contact area between the first gathering component 4 and the second gathering component 5 while simultaneously heat-sealing. The gathering and heat-sealing occur simultaneously. During this gathering process, excessive wrinkling at the bag opening is avoided, resulting in a more uniform thickness at the bag opening. Furthermore, the thickness of the bag opening during heat-sealing is significantly less than that of the gathered bag opening in the prior art. This allows for more thorough and uniform heat-sealing, thereby improving the sealing effectiveness and reducing the possibility of air leakage or seal breakage.

Specifically, the first gathering component 4 and the second gathering component 5 are only connected in the middle of the rear portion via a support.

Specifically, the first direction 17 is the width direction of the can body 1, and the second direction 18 is the length direction of the can body 1, or alternatively, the first direction 17 is the length direction of the can body 1, and the second direction 18 is the width direction of the can body 1. In this embodiment, the first direction 17 is the width direction of the can body 1, and the second direction 18 is the length direction of the can body 1.

Specifically, the heating element 6 is perpendicular to the extension direction of the garbage bag, ensuring that the heating element 6 can cut the garbage bag.

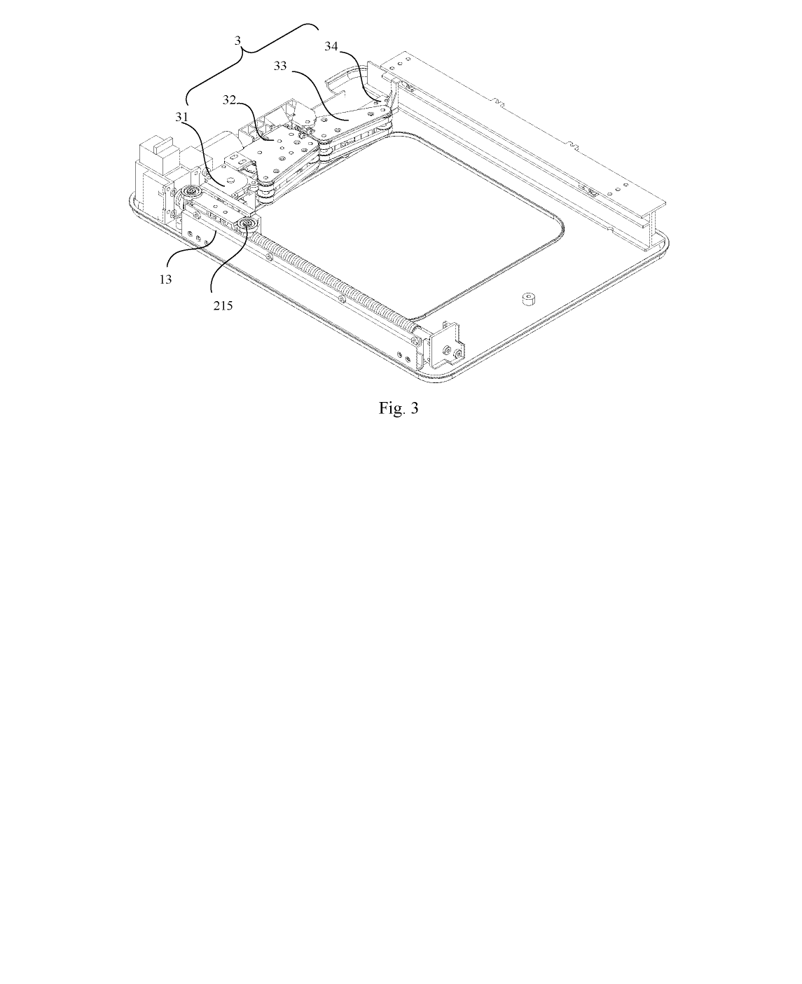

Referring to FIG. 3, the support structure 3 includes a first support bracket 31, a second support bracket 32, and a third support bracket 33 that are connected. The drive mechanism 2 is partially disposed within the first support bracket 31. The first gathering component 4 is disposed within the second support bracket 32, and the second gathering component 5 is disposed within the third support bracket 33.

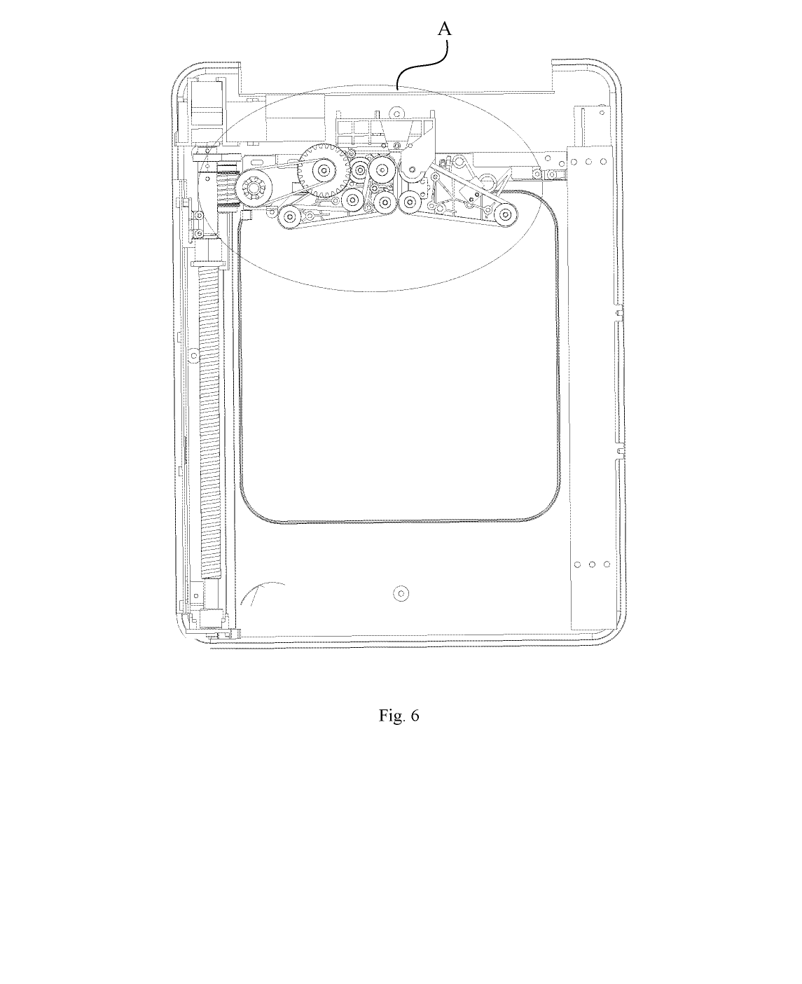

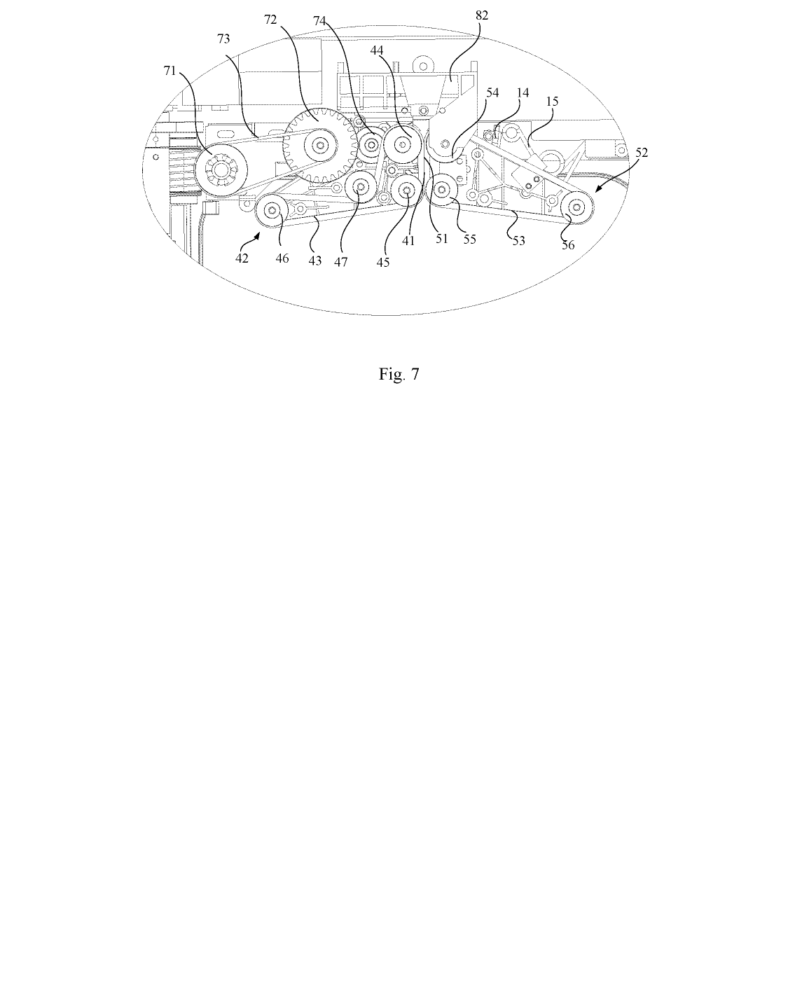

Specifically, referring to FIGS. 6-7, the first gathering component 4 has a first contact area 41, and the second gathering component 5 has a second contact area 51. The first contact area 41 and the second contact area 51 are in contact with each other, so as to gather the garbage bag between the first contact area 41 and the second contact area 51.

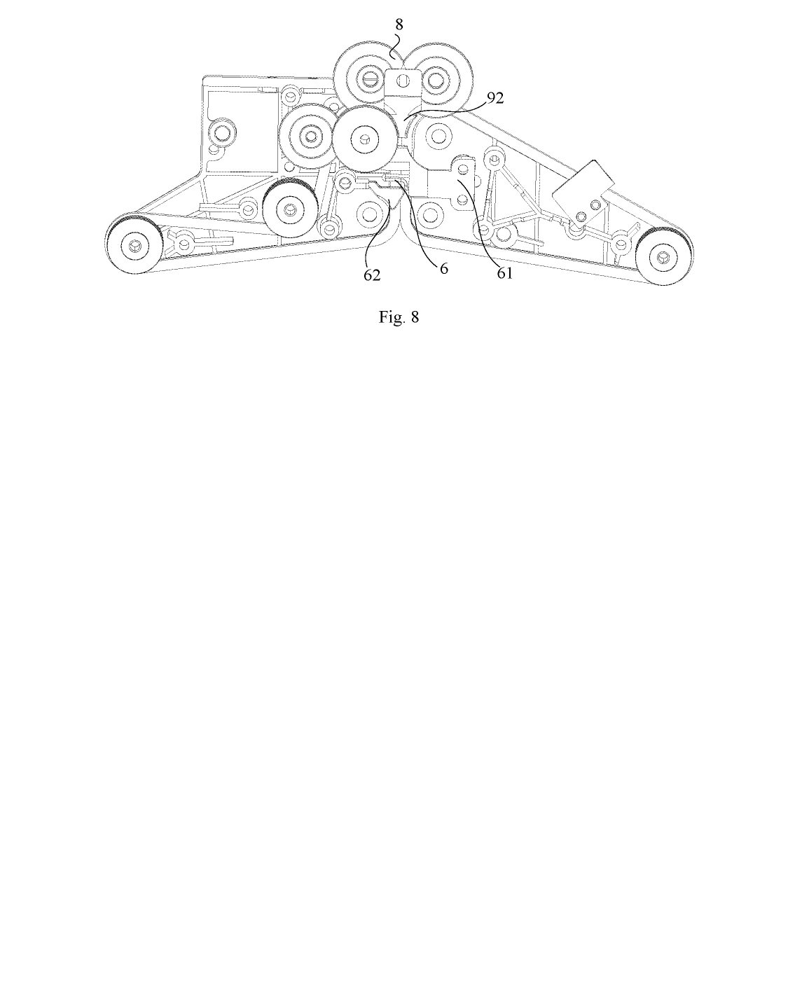

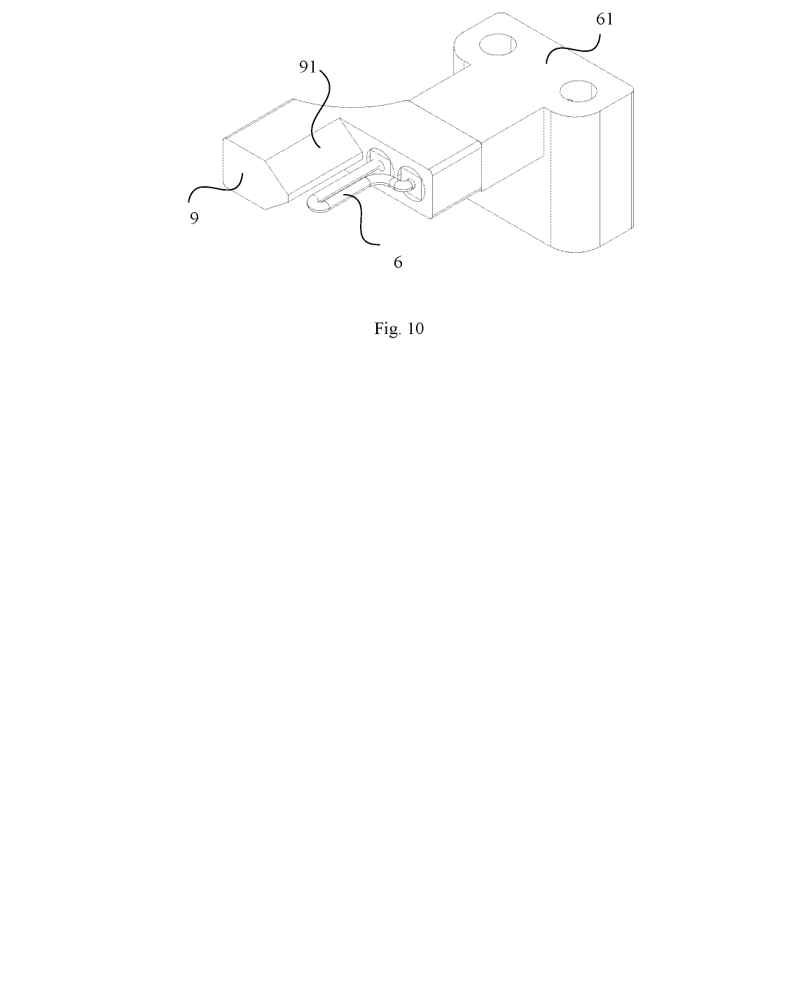

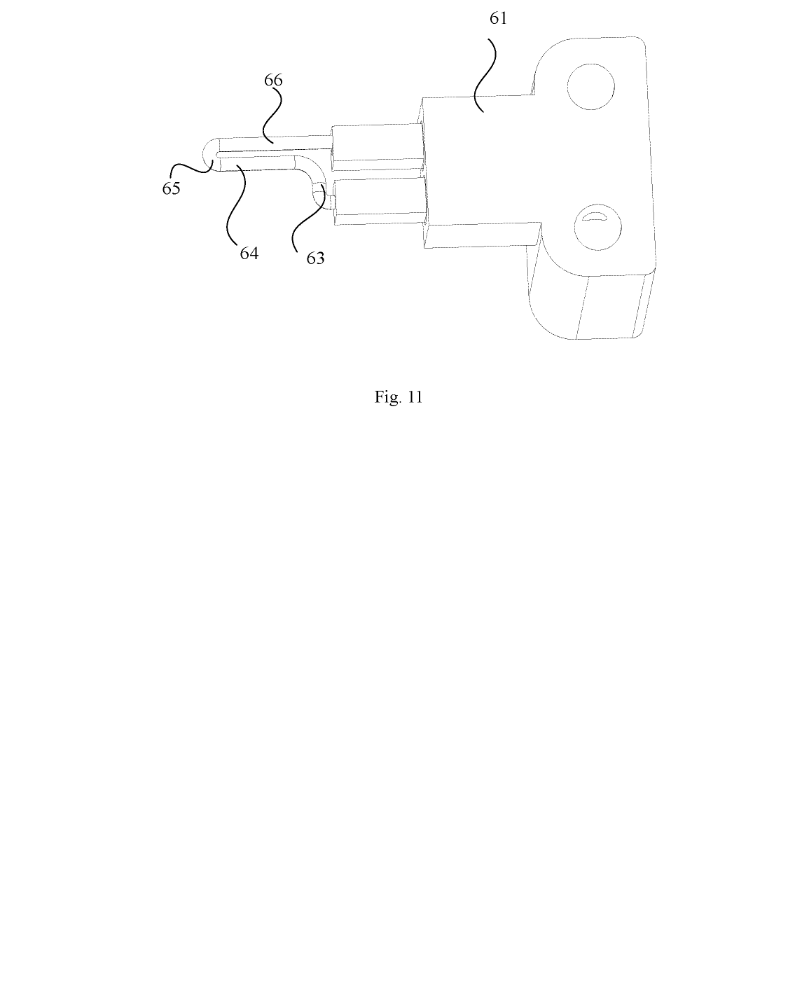

Referring to FIGS. 8-11, the trash can further includes a mounting part 61. The mounting part 61 is disposed on the bottom surface inside the third support bracket 33. The heating element 6 is disposed at the side of the mounting part 61 facing the first gathering component 4. The heating element 6 is fixedly mounted within the third support bracket 33 via the mounting part 61 and extends outside the second gathering component 5.

The heat-sealing structure of trash can further includes an abutting assembly 62. The abutting assembly 62 is disposed within the second support bracket 32. The abutting assembly 62 is arranged spaced apart from the first contact area 41 in the height direction of the can body 1 and protruding beyond a plane where the first contact area 41 is located in the direction toward the second contact area 51. Since the gap exists between both sides of the garbage bag during gathering, the abutting assembly 62 presses against the garbage bag to eliminate the gap after the garbage bag is gathered. This ensures the tight contact of the garbage bag during the gathering process, enabling uniform sealing without air leakage when the bag opening is heat-sealed, thereby further improving the sealing performance of the garbage bag.

Specifically, the abutting assembly 62 is disposed close to the center of the can body 1 relative to the heating element 6.

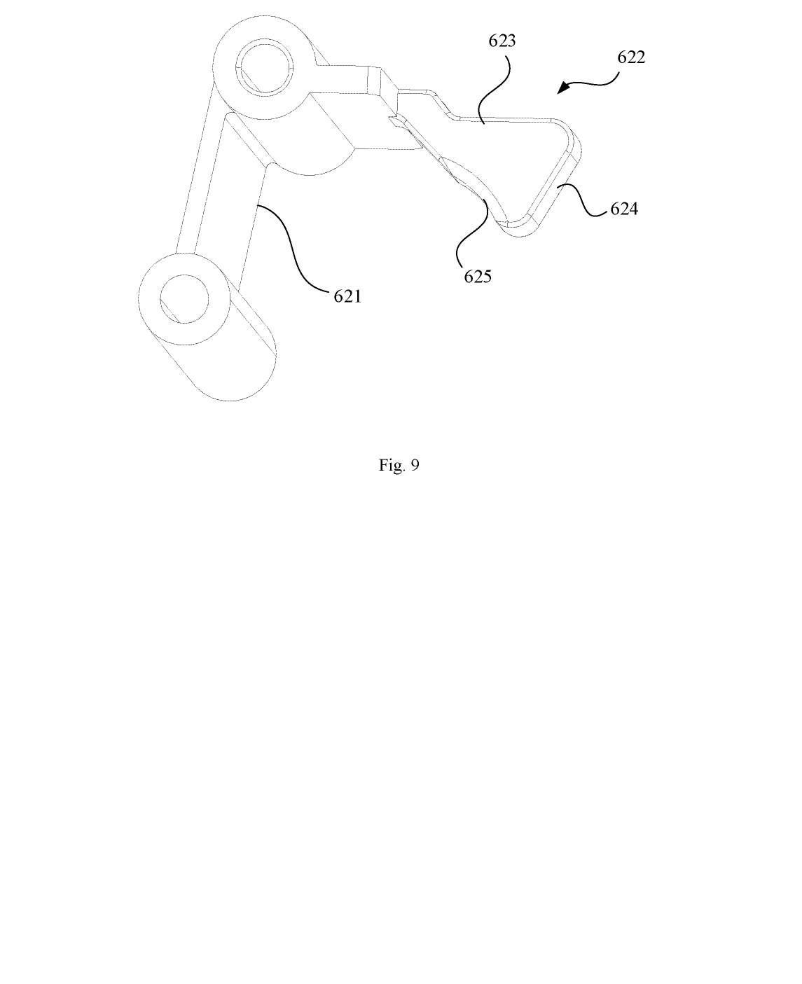

Specifically, as shown in FIG. 9, the abutting assembly 62 includes a positioning part 621 and a protruding part 622. The positioning part 621 is mounted on the bottom surface inside the second support bracket 32, and the protruding part 622 is arranged on the side of the positioning part 621. The protruding part 622 is arranged spaced apart from the first contact area 41 in the height direction of the trash can and protruding beyond the first contact area 41 in the direction toward the second contact area 51.

Furthermore, the protruding part 622 includes a first edge 623 and a second edge 624. A first end of the first edge 623 is connected to the positioning part 621, and a second end of the first edge 623 protrudes beyond the first contact area 41 and is connected to the second edge 624. The first edge 623 is arranged parallel to the width direction of the can body 1. The second edge 624 is arranged obliquely relative to the first edge 623. Specifically, the end of the second edge 624 away from the first edge 623 extends obliquely toward the second gathering component 5 until connecting with the first edge 623. The second edge 624 is connected to the first edge 623 via an arc transition to prevent the connection between the first edge 623 and the second edge 624 from puncturing the garbage bag opening.

Specifically, the second edge 624 obliquely passes through the first contact area 41 and the second contact area 51.

The protruding part 622 further includes a third edge 625. A first end of the third edge 625 is connected to the positioning part 621, and a second end of the third edge 625 is connected to the second edge 624. The first edge 623, the second edge 624, and the third edge 625 enclose a roughly triangular shape.

The heating element 6 includes a first bending part 63, a first heating part 64, a second bending part 65, and a second heating part 66. An end of the first bending part 63 is inserted into the mounting part 61. The second bending part 65 extends away from the protruding part 622 along the width direction of the can body 1 and is connected to the end of the first heating part 64. The first heating part 64 extends along the length direction of the can body 1 away from the mounting part 61 and is connected to a first end of the second bending part 65. A first end of the second heating part 66 is inserted into the mounting part 61, and the second end of the second heating part 66 is connected to the second end of the second bending part 65.

Specifically, a gap exists between the protruding part 622 and the first bending part 63 to allow the garbage bag to pass through.

Specifically, the heating element 6 protrudes beyond the second contact area 51. The first heating part 64 and the second bending part 65 protrudes beyond the second contact area 51. The second heating part 66 partially protrudes beyond the second contact area 51.

Furthermore, the extension direction of the first heating part 64 is parallel to that of the second heating part 66. By arranging the first heating part 64 and the second heating part 66 spaced apart along the first direction 17, it is possible to prevent the occurrence of unfused areas in the garbage bag.

Referring to FIGS. 1-7, the drive mechanism 2 includes a drive assembly 21 and a transmission assembly 22. Both the drive assembly 21 and the transmission assembly 22 are arranged within the accommodating groove 11 along the first direction 17. An end of the support structure 3 is connected to the drive assembly 21, and the drive assembly 21 is configured to drive the support structure 3 to reciprocate along the first direction 17. The transmission assembly 22 is partially disposed within the support structure 3. The transmission assembly 22 is in transmission connection with the drive assembly 21 and in transmission connection with the first gathering component 4.

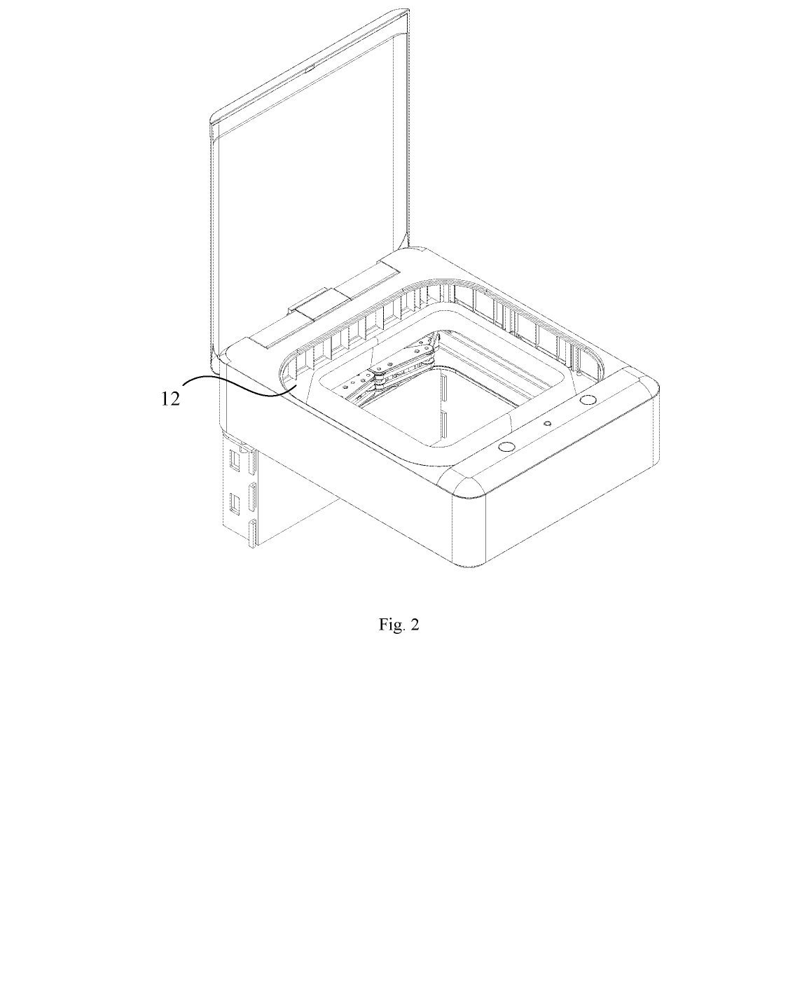

As shown in FIG. 2, the drive assembly 21 includes a motor 211, a transmission unit 212, a lead screw 213, and a lead screw nut 214. An end of the transmission unit 212 is connected to the motor 211, and the other end is connected to the lead screw 213. The lead screw nut 214 is threadedly connected to the lead screw 213, and the support structure 3 is connected to the lead screw nut 214. The motor 211 drives the transmission unit 212 to rotate, thereby causing the lead screw 213 to rotate and drive the lead screw nut 214 to reciprocate along the lead screw 213. The lead screw nut 214, in turn, drives the support structure 3 to move along the first direction 17.

Specifically, the drive assembly 21 further includes a guide wheel 215. The guide wheel 215 is connected to the support structure 3. A guide rail 13 is formed within the accommodating groove 11 along the first direction 17, and the guide wheel 215 is slidably connected to the guide rail 13.

The transmission assembly 22 includes a worm gear 221 and a transmission worm 222. The transmission worm 222 is in transmission connection with the transmission unit 212. The worm gear 221 is sleeved on the transmission worm 222. The motor 211 drives the transmission worm 222 to rotate via the transmission unit 212, thereby driving the worm gear 221 to rotate. The worm gear 221 is disposed within first support bracket 31. The support structure 3 is used to drive the worm gear 221 to reciprocate along the transmission worm 222. The worm gear 221 is also in transmission connection with the first gathering component 4.

Specifically, the transmission worm 222 is a square shaft.

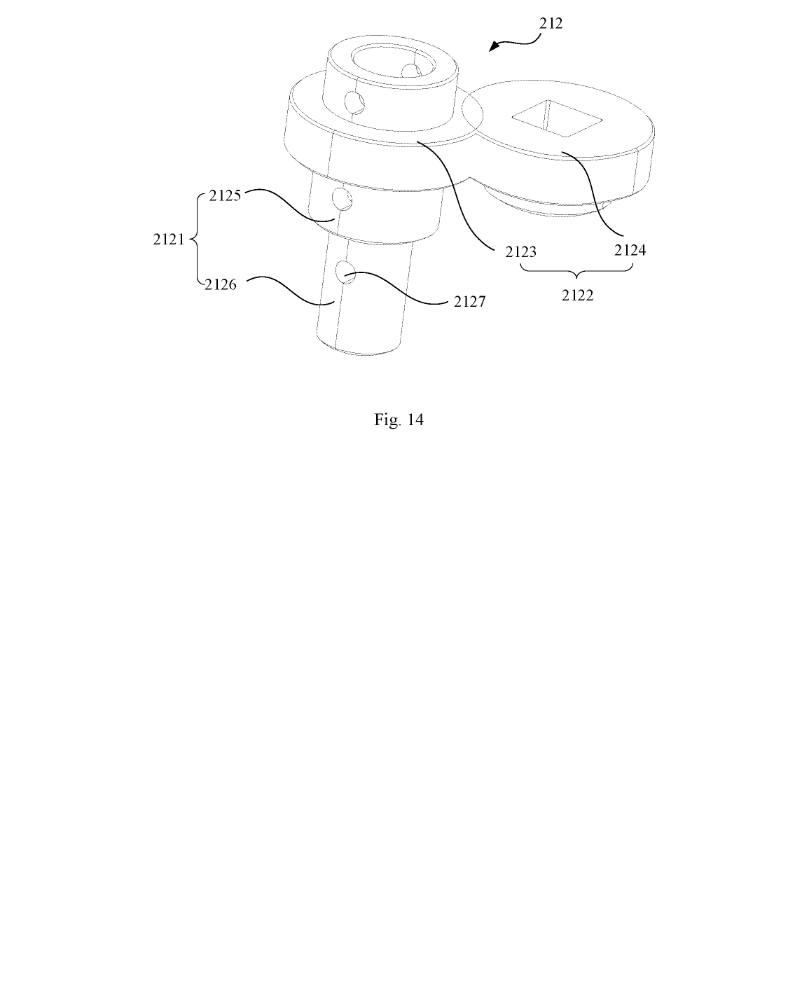

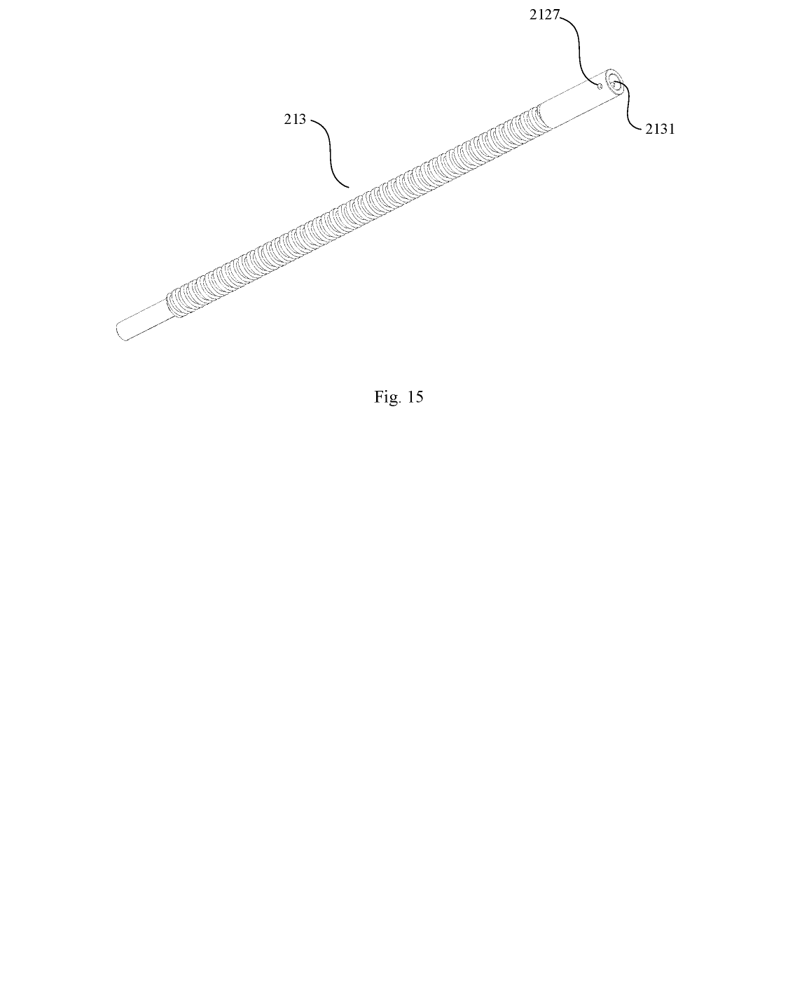

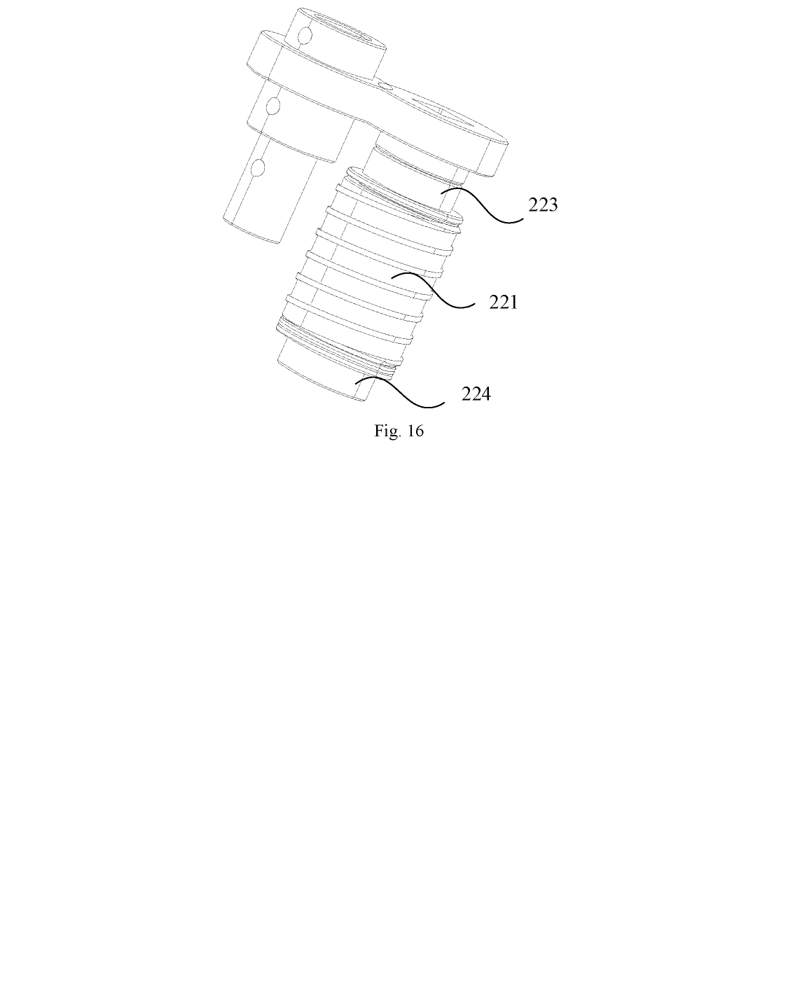

Referring to FIGS. 14-16, the transmission unit 212 includes a transmission shaft 2121 and a transmission gear set 2122. One end of the transmission shaft 2121 is connected to the output shaft of the motor 211, and the other end is connected to the lead screw 213. The transmission gear set 2122 is fixedly sleeved on the exterior of the transmission shaft 2121 and also in transmission connection with the transmission worm 222.

The transmission gear set 2122 includes a first transmission gear 2123 and a second transmission gear 2124. The first transmission gear 2123 is fixedly sleeved on the exterior of the transmission shaft 2121, and the second transmission gear 2124 is fixedly mounted on one end of the transmission worm 222. The first transmission gear 2123 and the second transmission gear 2124 are meshed to achieve synchronous rotation of the first transmission gear 2123 and the second transmission gear 2124.

The transmission shaft 2121 includes a first connecting section 2125 and a second connecting section 2126. The diameter of the first connecting section 2125 is larger than that of the second connecting section 2126. The first transmission gear 2123 is fixedly sleeved on the first connecting section 2125. An insertion slot 2131 is formed at one end of the lead screw 213. The second connecting section 2126 is inserted into the insertion slot 2131.

The drive assembly 21 further includes a connecting member and a connecting hole 2127. The connecting hole 2127 extends through the lead screw 213 and the second connecting section 2126. The connecting member is inserted through the connecting hole 2127 to achieve a fixed connection between the second connecting section 2126 and the lead screw 213. Specifically, the connecting member is a screw or bolt.

The transmission assembly 22 further includes a first bearing 223 and a second bearing 224. Both the first bearing 223 and the second bearing 224 are sleeved on the exterior of the transmission worm 222. The first bearing 223 and the second bearing 224 are respectively disposed at both ends of the transmission worm 222. The first bearing 223 is located between the second transmission gear 2124 and the worm gear 221. The configuration of the first bearing 223 and second bearing 224 ensures smooth rotation of the transmission worm 222.

In this disclosure, the motor 211 drives the lead screw 213 to rotate, thereby driving the lead screw nut 214, the support structure 3, and the worm gear 221 to move along the first direction 17. The motor 211 is also in transmission connection with the transmission worm 222. The motor 211 drives the transmission worm 222 to rotate, thereby driving the worm gear 221 to rotate. This achieves reciprocating movement and rotation of worm gear 221, enabling it to approach and gather the garbage bag. By utilizing the motor 211 as a single power source, this disclosure reduces the number of power sources compared to conventional multi-power source systems. This simplifies the system structure, lowers production costs, and avoids energy waste, achieving energy savings and environmental protection.

Referring to FIGS. 1-7, the trash can further includes a synchronous pulley assembly 7. The synchronous pulley assembly 7 is disposed within the second support bracket 32. The synchronous pulley assembly 7 includes a first synchronous pulley 71, a second synchronous pulley 72, and a synchronous belt 73. The first synchronous pulley 71 and the second synchronous pulley 72 are spaced apart within the second support bracket 32. The first synchronous pulley 71 meshes with the worm gear 221. The second synchronous pulley 72 is connected to the first gathering component 4 for transmission. The worm gear 221 drives the first synchronous pulley 71 to rotate. The synchronous belt 73 is entrained about both the first synchronous pulley 71 and the second synchronous pulley 72 to ensure the synchronous rotation of the first synchronous pulley 71 and the second synchronous pulley 72.

Referring to FIGS. 3-7, the trash can further includes an idler gear 74. The idler gear 74 is disposed between the second synchronous pulley 72 and the first gathering component 4. The second synchronous pulley 72 drives the rotation of the first gathering component 4 via the idler gear 74.

Specifically, the synchronous pulley assembly 7, the idler gear 74, and the first gathering component 4 are all disposed within the second support bracket 32.

The first gathering component 4 includes a first drive pulley assembly 42 and a first transmission belt 43. The first drive pulley assembly 42 is connected to the idler gear 74 for transmission. The first transmission belt 43 is mounted on the first drive pulley assembly 42 and moves along the outer wall of the first drive pulley assembly 42 driven by the first drive pulley assembly 42.

Specifically, the first drive pulley assembly 42 includes a first drive pulley 44, a second drive pulley 45, and a third drive pulley 46. The first transmission belt 43 is respectively mounted on the outer walls of the first drive pulley 44, the second drive pulley 45, and the third drive pulley 46. The first drive pulley 44 is connected to the idler gear 74 for transmission. The first drive pulley 44, the second drive pulley 45, and the third drive pulley 46 enclose a triangular shape.

In this embodiment, the first drive pulley 44 includes two belt pulleys and a gear. The gear is disposed between the two belt pulleys and coaxially arranged with the two belt pulleys. The second drive pulley 45 is formed by a combination of two coaxially arranged belt pulleys of identical size. The third drive pulley 46 is formed by two coaxially arranged pulleys belt of identical size. There are two first transmission belts 43. One of the first transmission belts 43 is mounted on the first drive pulley 44, the second drive pulley 45, and the third drive pulley 46 at the top. The other one of the first transmission belts 43 is mounted on the first drive pulley 44, the second drive pulley 45, and the third drive pulley 46 at the bottom. The idler gear 74 meshes with the intermediate gear of the first drive pulley 44 for transmission.

The first drive pulley assembly 42 further includes a tension pulley 47. The outer wall of the tension pulley 47 abuts against the first transmission belt 43.

Specifically, an edge of the first drive pulley 44 and an edge of the second drive pulley 45 proximate to the second gathering component 5 are aligned.

Specifically, the protruding part 622 is located between the first drive pulley 44 and the second drive pulley 45, and the protruding part 622 is positioned within the gap formed by the two first transmission belts 43. Two first transmission belts 43 increases the gathering area for the garbage bag. The protruding part 622 and the heating element 6 are disposed within between the gap of the two first transmission belts 43, thereby separating the fused bag opening from the remaining bag body.

Referring to FIG. 7, the second gathering component 5 includes a second drive pulley assembly 52 and a second transmission belt 53. The second drive pulley assembly 52 is in transmission connection with the first drive pulley assembly 42. The second transmission belt 53 is entrained about the second drive pulley assembly 52 and is driven by the second drive pulley assembly 52 to move along the outer walls of the second drive pulley assembly 52. The first contact area 41 is located on the first transmission belt 43, and the second contact area 51 is located on the second transmission belt 53.

Specifically, the second drive pulley assembly 52 includes a first transmission pulley 54, a second transmission pulley 55, and a third transmission pulley 56. The second transmission belt 53 is respectively entrained about the outer wall of the first transmission pulley 54, the outer wall of the second transmission pulley 55, and the outer wall of the third transmission pulley 56. The first transmission pulley 54 is connected to the first drive pulley 44 for transmission. The first transmission pulley 54, the second transmission pulley 55, and the third transmission pulley 56 are arranged to form a triangular shape.

Specifically, an edge of the first drive pulley 44 and an edge of the second drive pulley 45 proximate to the second gathering component 5 are aligned. The edges of the first transmission pulley 54 and the second transmission pulley 55 are aligned. Furthermore, an edge of the first transmission belt 43 proximate to the second gathering component 5 is parallel to and tightly adjoins the edge of the second transmission belt 53 close to the first gathering component 4, thereby forming the first contact area 41 and the second contact area 51.

Specifically, the first drive pulley 44 and the first transmission pulley 54 are of identical size. The second drive pulley 45 and the second transmission pulley 55 are of identical size. The third drive pulley 46 and the third transmission pulley 56 are of identical size. This configuration ensures that the first drive pulley assembly 42 and the second drive pulley assembly 52 rotate at the same speed.

In this embodiment, the first transmission pulley 54 includes two belt pulleys and a gear. The gear is positioned between the two belt pulleys and coaxially arranged with both belt pulleys. The second transmission pulley 55 is formed by a combination of two coaxially arranged belt pulleys of identical size. The third transmission pulley 56 is formed by two belt pulleys of the same size arranged coaxially. There are two second transmission belts 53. One of the second transmission belts 53 is entrained about the first transmission pulley 54, the second transmission pulley 55, and the third transmission pulley 56 at the top, and the other one of the second transmission belts 53 is mounted on the first transmission pulley 54, the second transmission pulley 55, and the third transmission pulley 56 at the bottom.

Specifically, the heating element 6 is positioned between the first transmission pulley 54 and the second transmission pulley 55, and the heating element 6 is disposed within the gap formed by the two second transmission belts 53.

The trash can further includes a rear pulley assembly 8. The rear pulley assembly 8 is mounted within the support structure 3 and located between the first drive pulley 44 and the first transmission pulley 54. The first transmission pulley 54 is connected to the first drive pulley 44 via the rear pulley assembly 8 for transmission.

In this embodiment, two rear pulleys 81 are provided. One side of the first rear pulley meshes with the intermediate gear of the first drive pulley 44 for transmission, and the other side of the first rear pulley meshes with one side of the second rear pulley for transmission. The other side of the second rear pulley meshes with the intermediate gear of the first transmission pulley 54 for transmission.

The trash can further includes rear support blocks 82. The rear pulleys 81 are rotatably mounted within the rear support blocks 82. The rear support blocks 82 are respectively connected to the second support bracket 32 and the third support bracket 33. The second support bracket 32 drives the rear support blocks 82 to move along the first direction 17, thereby driving the rear pulleys 81 to move along the first direction 17. The rear support blocks 82 also drive the third support bracket to move along the first direction 17.

The trash can further includes a first guiding inclined platform 9. The first guiding inclined platform 9 is located on the side of the mounting part 61 facing the first gathering component 4. The first guiding inclined platform 9 is spaced apart from the heating element 6 and is located on the side of the heating element 6 away from the center of the can body 1. The first guiding inclined platform 9 has two upper and lower first inclined surfaces 91 that forms a cutting edge. The first inclined surfaces 91 face the heating element 6. As the support structure 3 moves along the first direction 17, the first inclined surfaces 91 facilitate the separation of the garbage bag from top and bottom.

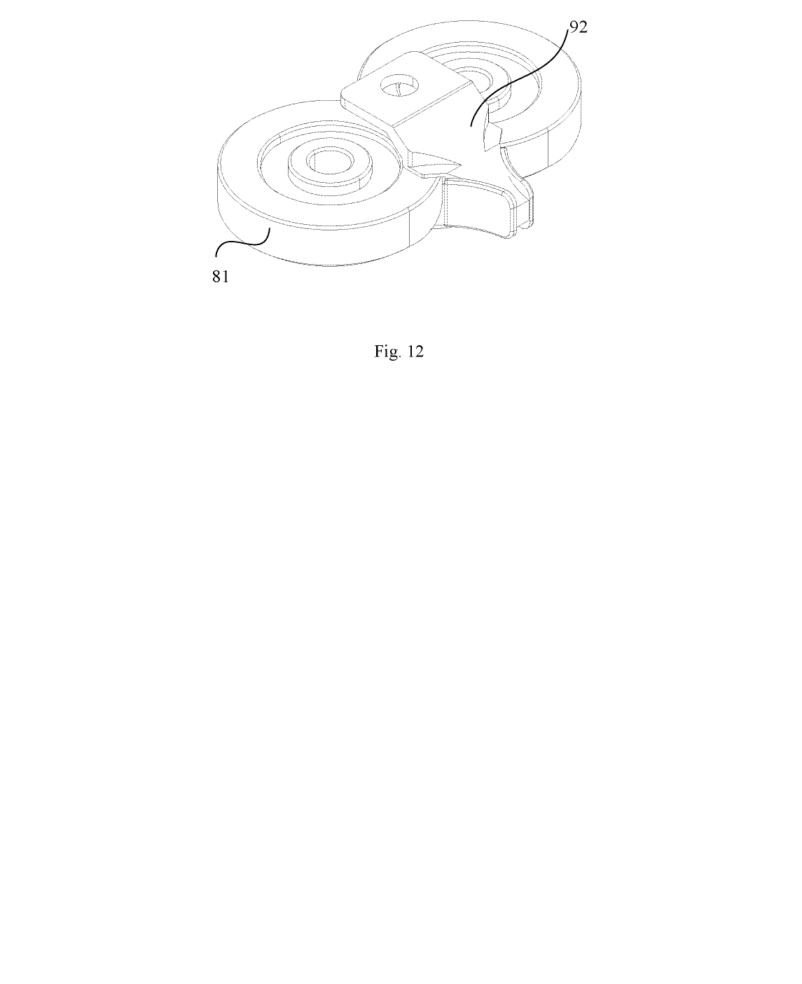

As shown in FIG. 12, the trash can further includes a second guiding inclined platform 92. The second guiding inclined platform 92 is positioned on the rear support block 82. The second guiding inclined platform 92 is spaced apart from the first guiding inclined platform 9. The second guiding inclined platform 92 is positioned on the side of the first guiding inclined platform 9 away from the heating element 6. The second guiding inclined platform 92 has a second inclined surface 93, which is substantially parallel to the first inclined surface 91. The second inclined surface 93 guides the separated upper and lower parts of the fused garbage bag to move rearward, preventing accumulation of the garbage bag.

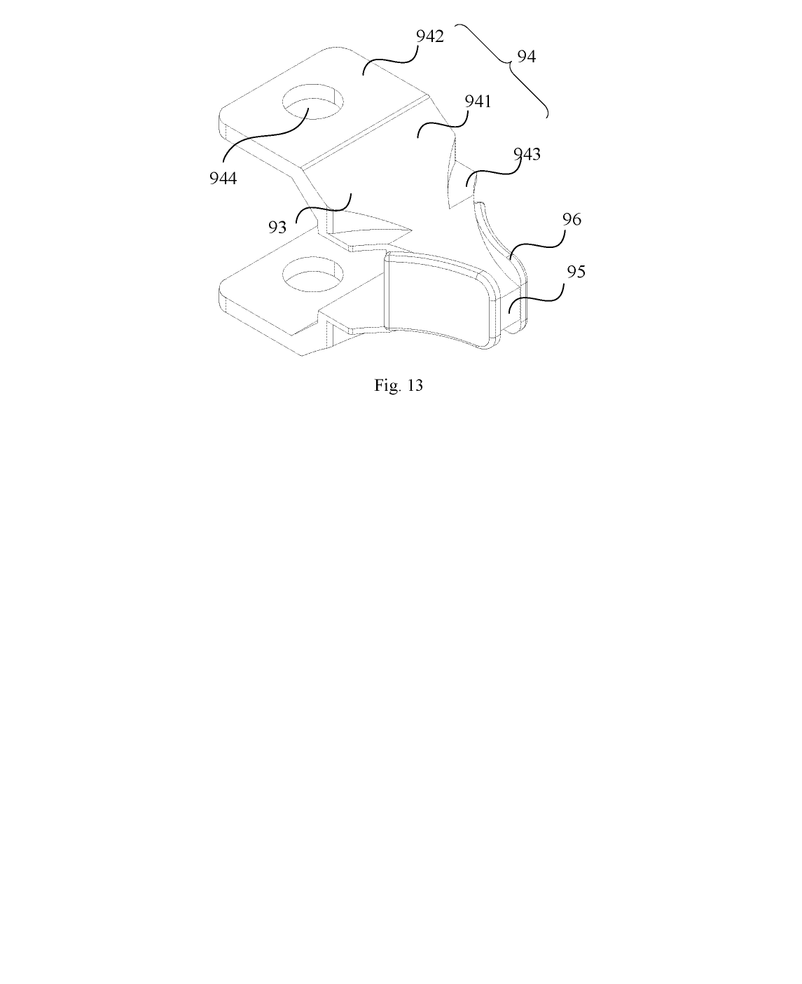

Specifically, as shown in FIG. 13, the second guiding inclined platform 92 includes two pushing arms 94 and a connecting member 95. The two pushing arms 94 are arranged symmetrically vertically. The connecting member 95 is positioned between the two pushing arms 94. The pushing arm 94 is formed with the second inclined surface 93. The two pushing arms 94 and the connecting member 95 are integrally formed.

Furthermore, the pushing arm 94 includes a pushing portion 941, a fixing portion 942, and a clamping portion 943. The pushing portion 941 is connected to the fixing portion 942. The fixing portion 942 is arranged horizontally, and the pushing portion 941 is inclined relative to the fixing portion 942. The fixing portion 942 has a fixing hole 944. The second guiding inclined platform 92 is fixedly connected to the rear support block 82 by a fastener passing through the fixing hole 944. The clamping portion 943 is located in the middle of the pushing portion 941. The clamping portion 943 is located on two sides of the pushing portion 941. The two rear pulleys 81 are respectively housed within the two clamping portions 943.

The second guiding inclined platform 92 further includes a retaining edge 96. The retaining edge 96 is positioned on one side of the pushing arm 94. Specifically, there are two retaining edges 96, which are positioned on opposite sides of the second inclined surface 93. This arrangement ensures that the bag opening continues moving along the second inclined surface 93, thereby being cut.

By providing the first guiding inclined platform 9 and the second guiding inclined platform 92, the disclosure achieves complete separation between the bag opening from the remaining bag body.

Referring to FIG. 7, the disclosure further includes a sensor 14. The sensor 14 is located within the accommodating groove 11. The support structure 3 also includes a fourth support bracket 34. One end of the fourth support bracket 34 is connected to the third support bracket 33, and the other end of the fourth support bracket 34 is slidably connected to the side wall of the accommodating groove 11. The fourth support bracket 34 can move along the first direction 17 driven by the third support bracket 33. The fourth support bracket 34 is positioned below the third support bracket 33, and the sensor 14 is mounted on the fourth support bracket 34.

An end of the third support bracket 33 is rotatably connected to the rear support block 82 via a pivot shaft. The pivot shaft is coaxial with the first transmission pulley 54. The third support bracket 33 and the second gathering component 5 can rotate about the pivot shaft. When protrusions within the garbage bag obstruct the bag sealing process, the protrusions cause the second gathering component 5 and the third support bracket 33 to rotate as a whole around the pivot shaft in a direction away from the first gathering component 4. When the third support bracket 33 rotates to the point of contacting the sensor 14, the sensor 14 sends a signal, triggering an alarm from the trash can.

Specifically, the disclosure further includes a reset spring 15. One end of the reset spring 15 is connected to the side wall of the can body 1, and the other end of the reset spring 15 is connected to the other end of the third support bracket 33. After the trash can issues an alarm, the user removes the protrusions. This allows the third support bracket 33 and the second gathering component 5 to reset under the action of the reset spring 15, restoring the trash can to normal operation.

The trash can further includes a controller 16. The controller 16 is mounted on the can body 1 and is electrically connected to both the motor 211 and the sensor 14. The controller 16 is used to control the starting and stopping of the motor 211 and receive the signal from the sensor 14 to trigger the alarm.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A heat-sealing structure for a trash can, the trash can comprising a gathering assembly, the heat-sealing structure being arranged in the gathering assembly, the gathering assembly comprising a first gathering component and a second gathering component, the first gathering component having a first contact area, the second gathering component having a second contact area, the first contact area being configured to be in contact with the second contact area, a garbage bag being configured to be gathered between the first contact area and the second contact area, and the heat-sealing structure comprising:
an abutting assembly; and
a heating element;
wherein the abutting assembly is arranged at the first gathering component; the abutting assembly is arranged spaced apart from the first contact area and protruding beyond a plane where the first contact area is located; the abutting assembly is configured to press against the garbage bag to eliminate a gap after the garbage bag is gathered, thereby ensuring two sides of the garbage bag in contact with each other; and
the heating element is arranged at the second gathering component; the heating element is arranged spaced apart from the second contact area and protruding beyond the second contact area; and the heating element is arranged spaced apart from the abutting assembly, and is configured to thermally seal the garbage bag.

2. The heat-sealing structure of claim 1, wherein the abutting assembly comprises a positioning part and a protruding part; the positioning part is arranged at the first gathering component; the protruding part is arranged on a side of the positioning part; and the protruding part is arranged spaced apart from the first contact area and protruding beyond the first contact area.

3. The heat-sealing structure of claim 2, wherein the protruding part comprises a first edge and a second edge; a first end of the first edge is connected to the positioning part, and a second end of the first edge protrudes beyond the first contact area and is connected to the second edge; and the second edge is configured to extend obliquely from the second end of the first edge and pass through at least a portion of the second contact area and at least a portion of the first contact area.

4. The heat-sealing structure of claim 3, wherein the protruding part further comprises a third edge; and a first end of the third edge is connected to the positioning part, and a second end of the third edge is connected to the second edge.

5. The heat-sealing structure of claim 1, further comprising:
a mounting part;
wherein the mounting part is provided on the second gathering component; the heating element is provided on a side of the mounting part facing toward the first gathering component; and the heating element is arranged perpendicular to an extension direction of the garbage bag.

6. The heat-sealing structure of claim 5, wherein the heating element comprises a first bending part and a first heating part; an end of the first bending part is inserted into the mounting part; and a gap is provided between the abutting assembly and the first bending part for the garbage bag to pass through; and the first heating part is configured to thermally seal the garbage bag.

7. The heat-sealing structure of claim 6, wherein the heating element further comprises a second bending part and a second heating part; a first end of the second bending part is connected to an end of the first heating part; a second end of the second bending part is connected to a first end of the second heating part; and a second end of the second heating part is inserted into the mounting part.

8. The heat-sealing structure of claim 7, wherein an extension direction of the first heating part is parallel to an extension direction of the second heating part.
